(19) United States
(12) Patent Application Publication
(10) Pub. No.: US 2010/0196083 A1
(43) Pub. Date: Aug. 5, 2010

(54) CLIP REPORT COVER HAVING A CLIP EDGE THAT CAN BE LOWERED INTO A GROOVE OR A SLIT

(75) Inventor: Lutz Koebele-Lipp, Berlin (DE)

Correspondence Address: OUIMET LAW OFFICES, 1800 9TH AVENUE, # 1630, SEATTLE, WA, 98101, US

(73) Assignee: Alevtina Michaylovna SEVASTYANOVA, St. Petersburg (RU)

(21) Appl. No.: 12/676,312

(22) PCT Filed: Sep. 6, 2007
(86) PCT No.: PCT/DE07/01607

§ 371 Date: Mar. 3, 2010

(51) Int. Cl. B42F 3/04

(52) U.S. Cl. 402/71

(57) ABSTRACT

A clip report cover for unpunched documents (16) comprises a U-shaped clip element that is formed by a retaining piece (7), a connecting rib (8), and a clip piece (9) and extends across the clip report cover in the swiveled-in or inserted state. The clip edge (12) of the clip piece (9) is lowered beyond the clip plane (19) of the retaining piece (7), preferably into a clip slot (14) configured in the retaining piece (7) or a retaining piece groove such that the documents remain securely clamped even after reducing the stack height.

The invention relates to a clip report cover for unpunched documents, consisting of a report cover back and a report cover front, and a substantially U-shaped elastic clip element which extends across the report cover back and the report cover front in a swivelable or movable manner and which has a retaining piece engaged with the report cover back and a clip piece with a clip edge, which clip piece is elastically attached to the retaining piece by means of a connection rib and is lowered towards the front edge of the retaining piece.

Clip report covers or folders for loosely inserted, unpunched documents usually consist of a report cover back and a report cover front which are connected at a longitudinal side by means of a fold. A paper stack inserted into the clip report cover or folder is clamped between the back and the front of a substantially U-shaped clip element which is made of elastic material and which is movably attached in the middle of the folder and close to the fold, and which extends across the outer surfaces of the folder without damaging the inserted paper in an undesired manner.

For a clip report cover known from EP 0 609 568, the clip element consisting of an elastic material, for example plastic or sheet metal, comprises a substantially planar retaining piece which is attached with its upper end to the report cover back and which is swivelable about a vertical axis, and an elastically configured clip piece which is integrally molded by means of a connection rib onto the longitudinal side of the retaining piece. The retaining piece is formed longer than the clip piece, wherein on an upper elongated end of the retainer piece, an opening to its swivelable mounting on the report cover back is formed. In the swiveled-in state of the clip element, the report cover back and the report cover front and the documents inserted therebetween are clamped between the retaining piece and the clip piece. After swiveling out, the clip element is not engaged anymore with the back and the front of the clip report cover so that the paper stack or portions thereof can be removed, or new documents can be added, or the removed paper stack can be replaced by a bigger or a smaller one.

However, the known clip report covers with swivelable clip elements or clip elements that can be slid on are disadvantageous in that a clip report cover previously used for a thick paper stack can not be used again satisfactorily for fixation of a thinner paper stack because the clamping force of the clip element or the elastic clamping effect of the material has weakened in the meantime, and the clip opening between retaining piece and clip piece has widened in the meantime, and therefore, the documents can slip out. In this case, a complicated handling of the clip element is an obstacle for a reduction of the clip gap width.

The invention is based on the object to further develop a clip report cover with swivelable clip element in such a manner that even in case of repeated use with reduced paper stack thickness, a secure clamping of the documents is ensured, and, furthermore, a simple handling of the clip element is ensured.

According to the invention, the object is solved with a clip report cover configured according to the features of the patent claim 1.

For a generic clip report cover, the basic idea of the invention is that the clip edge of the clip piece is lowered below the clip plane of the retainer clip, this means, the clip gap width has a negative value so that even in case of a reduced stack height compared to the previously clamped document stack, a sufficient clamping force is ensured. The negative clip gap width is preferably achieved in that the elastic clip piece plunges with its clip edge into a clip slot or into a rounded retaining piece groove formed within the retaining piece in such a manner that the paper stack is not only frictionally locked in place, but is also positively locked in place due to a small recess or indentation formed in the paper stack above the clip slot or in the retaining piece groove. A swivelably formed clip element is preferably hinged at its lower end to the clip report cover or to the report cover back in such a manner that the clip element is arranged in an ergonomically advantageous manner and, furthermore, with the clamping effect improved according to the invention, can easily be moved with one hand. However, the clip element can also be retained on the clip report cover in a slidable manner.

Advantageous developments and useful configurations of the invention are revealed by the embodiment of a clip report cover exemplary described below and by the sub-claims.

One embodiment of the invention is illustrated in more detail by means of the drawing. In the Figures:

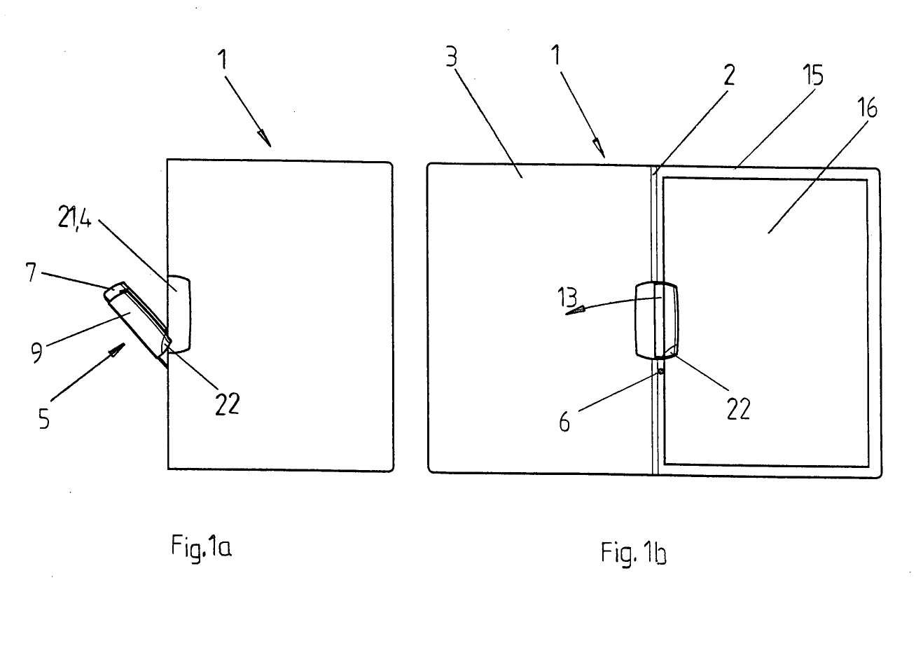

FIG. 1a shows a top view of a clip report cover with swiveled-out clip element;

FIG. 1b shows a top view on an opened clip report cover according to FIG. 1a, but with a swiveled-in clip element clamping a document stack;

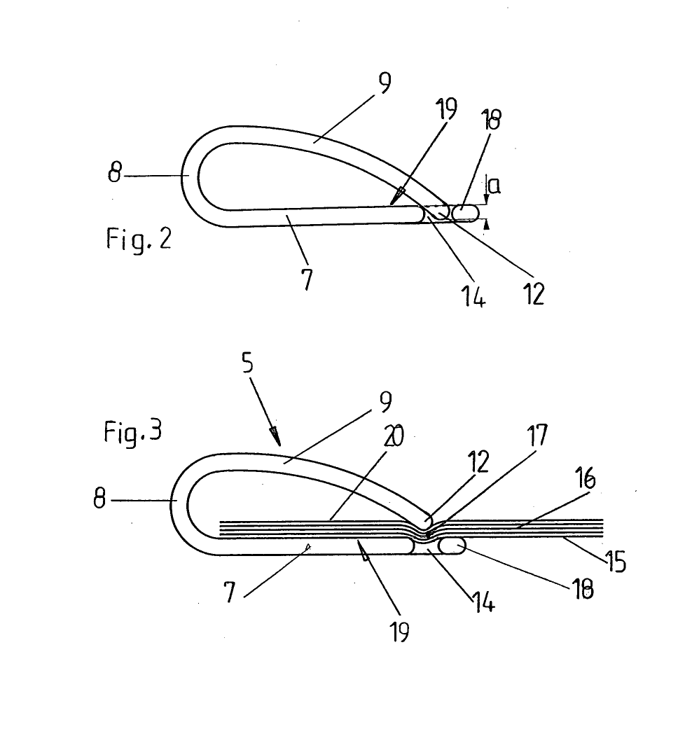

FIG. 2 shows a schematic sectional view of a clip element with a clip slot and without document stack;

FIG. 3 shows a schematic sectional view of a clip element according to FIG. 2 with a clamped document stack;

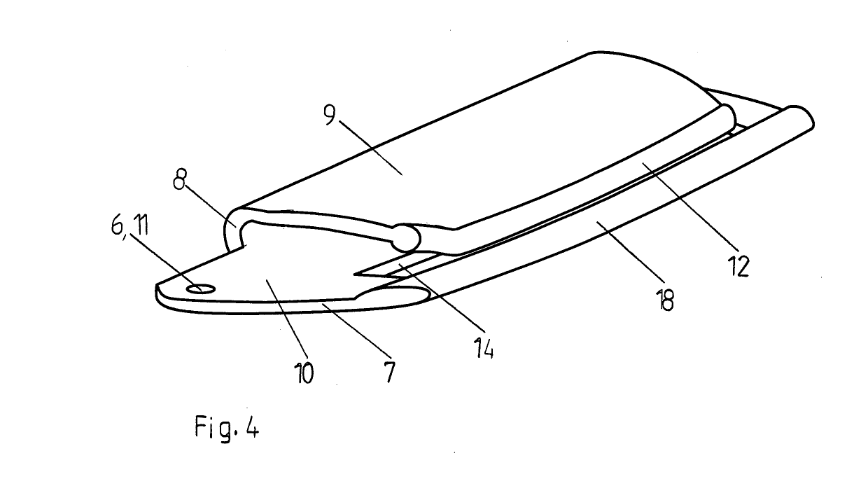

FIG. 4 shows a perspective view of a clip element with clip slot;

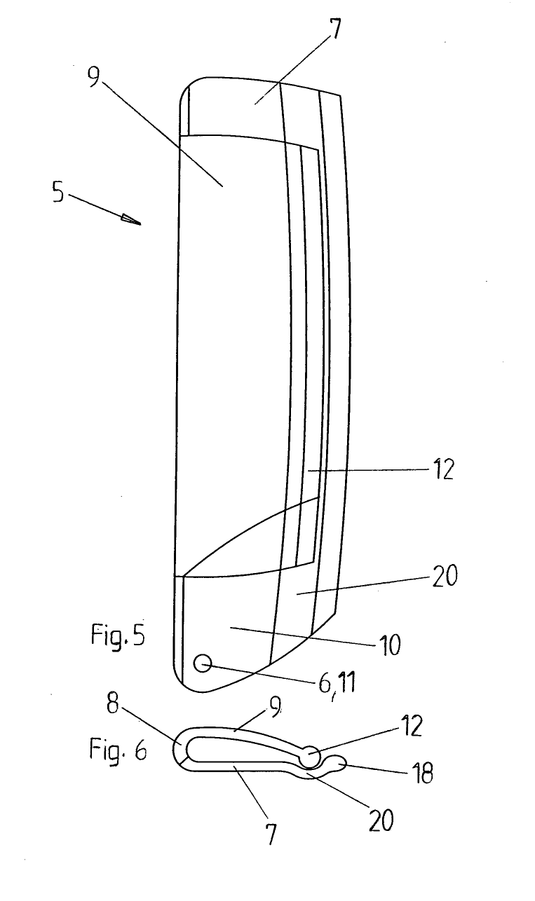

FIG. 5 shows a top view of a clip element with a groove integrally formed into the retaining piece; and

FIG. 6 shows a sectional view of the clip element according to FIG. 5.

The clip report cover 1 comprises a report cover back 15 and a report cover front 3 connected with, viewed in the drawing plane, the left edge of the report cover back by means of a fold 2. Starting from the fold 2, a window 4 is cut out from the report cover front 3. In the area of the window 4, a clip element 5 is attached which is rotatable about a pivot point 6. The substantially U-shaped clip element 5 consists of a retaining piece 7 and of a clip piece 9 which is integrally connected with the retaining piece by means of a connecting rib 8, and which is curved and lowered towards the retaining piece 7. The clip element 5 is made of an elastically deformable rigid plastic. The retaining piece 7, the inner surface of which is arranged opposite to the outer surface of the report cover back and which is formed longer than the clip piece 9, has in its lower section 10 extending beyond the clip piece, a bore hole 11 by means of which, together with a rivet (not shown), the clip element 5 is swivelably connected with the report cover back 15. In the swiveled-out position shown in FIG. 1a, documents can be inserted or can be removed. In the folded-out illustration of the report cover 1 shown in FIG. 1b, the clip element 5 extends across the report cover back and across a flap 21 which remains therein after cutting out the window 4, and which is connected with the fold 2. A document stack 16, which is inserted in the report cover 1 and which is also covered by the flap 21 in the area of the window 4, is hence clamped by the free clip edge 12 of the elastically configured clip element 5 in its swiveled-in state. When the clip element 5 is swiveled away from the fold 2 in direction of the arrow 13, the documents are free within the report cover 1 and can be taken out as a whole or in parts.

Even in case of a considerable reduction of the height of the document stack, the clamping effect of the repeatedly swiveled-in clip element 5, which extends across the report cover back and the document stack (along with the flap 21 remaining in window 4), is still maintained due to its specific configuration explained below. As the FIGS. 2 to 4 show, arranged in retaining piece 7 is a clip slot 14 which runs parallel to the front edge of the retaining piece and which is arranged opposite to the clip edge 12, into which clip slot the clip edge 12 according to FIG. 2 can plunge in the swiveled-in state of the clip element 5 so that the clip gap width can assume a negative value “a” and that hence the clamping effect can be increased. Because the report cover back 15 and the document stack 16 are located above the clip slot 14 and cover the same, as FIG. 3 shows, the clip edge 12 pushes the document stack 16 together with flap 21 slightly into the clip slot 14, this means below the clip plane 19 of the retaining piece 7 so that, on the one hand, the clamping effect is increased and, on the other hand, the document is not only frictionally locked in place, but is also positively locked in place in a small recess 17. By means of the combination of a friction-locked and a positive-locked fixation, a height-reduced document stack 16 is still securely retained in the clip report cover 1 during continued use.

For the simple handling of the clip report cover, the easy actuation of the clip element 5 is of importance due to the pivot point 6 at the bottom. The clip element 5 is arranged in an ergonomically advantageous manner due to the pivot point 6 provided at the lower end of the clip piece 7 and thus can be easily actuated with a movement of the hand. Furthermore, the clip edge 12 of the clip piece 9 and the front edge 18 of the retaining piece 7 are bead-like rounded to facilitate the movability of the clip element 5 and to provide a paper-preserving, nicely rounded recess 17 in the document stack 16. In addition, a part of the clip piece's 9 front side pointing towards the pivot point 6 is opened jaw-like (insertion jaw 22) so that the clip element 5 can easily be slid on during swiveling-in.

FIGS. 5 and 6 show yet another embodiment of a swivelably configured clip element 5, in the retaining piece 7 of which, instead of the clip slot 14, a retaining piece groove 20 is integrally formed in such a manner that the clip edge 12 of the clip piece 9 can be lowered below the clip plane 19 of the retaining piece 7. In the sectional view according to FIG. 6, the nicely rounded configuration of the clip edge 12, and of the retaining piece groove 20, and of the front edge 18 of the retaining piece 7 is shown.

### REFERENCE LIST

1 Clip report cover
2 Fold
3 Report cover front
4 Window
5 Clip element
6 Pivot point
7 Retaining piece
8 Connecting rib
9 Clip piece
10 Lower section of 7
11 Bore hole in 10
12 Clip edge of 9
13 Arrow
14 Clip slot
15 Report cover back
16 Document stack
17 Recess in 16
18 Front edge of 7
19 Clip plane of 7
20 Retaining piece groove, clip groove
21 Flap
22 Insertion jaw

1. A clip report cover for unpunched documents, consisting of a report cover back (15) and a report cover front (3), and of a substantially U-shaped elastic clip element which extends across the report cover back and the report cover front in a swivelable or movable manner and which has a retaining piece (7) engaged with the report cover back and a clip piece (9) with a clip edge (12), which clip piece is elastically attached to the retaining piece by means of a connection rib (8) and is lowered towards the front edge of the retaining piece (7), characterized in that for the improvement of the clamping effect, the clip edge (12) of the clip piece (9) is lowered beyond a clip plane (19) of the retaining piece (7).

2. The clip report cover according to claim 1, characterized in that the retaining piece (7) has a retaining piece groove (20) which runs close and parallel to the front edge (18) of the retaining piece and which is arranged opposite to the clip edge (12) of the clip piece (9).

3. The clip report cover according to claim 1, characterized in that the retaining piece (7) has a clip slot (14) which runs close and parallel to the front edge (18) of the retaining piece and which is arranged opposite to the clip edge (12) of the clip piece (9).

4. The clip report cover according to claim 2, characterized in that the clip edge (12) is shorter than the retaining piece groove (20), and is lowered into the same.

5. The clip report cover according to claim 2, characterized in that the retaining piece groove (20) and the clip edge (12) are formed rounded.

6. The clip report cover according to claim 1, characterized in that in the area of the report cover front (3) covered by the swiveled-in or slid-on clip element (5), a window (4) is cut, thereby forming a flap (21) remaining on the report cover back (15).

7. The clip report cover according to claim 1, characterized in that the clip element (5) consists of a thermosetting or metallic, elastically deformable material.

8. The clip report cover according to claim 1, characterized in that a swivelably configured clip element (5) is retained with its retaining piece (7) in a pivot point (6) at the report cover back (15), and the clip piece's (9) part pointing towards the pivot point (6) is bulged to form a insertion jaw (22) for facilitating the swiveling-in of the clip element (5).

9. The clip report cover according to claim 8, characterized in that the pivot point (6) is provided at the bottom of the clip element (5).

10. The clip report cover according to claim 3, characterized in that the clip edge (12) is shorter than the clip slot (14), and is lowered into the same.

11. The clip report cover according to claim 3, characterized in that the longitudinal edges of the clip slot (14) and the clip edge (12) are formed rounded.

12. The clip report cover according to claim 4, characterized in that the retaining piece groove (20) and the clip edge (12) are formed rounded.

13. The clip report cover according to claim 10, characterized in that the longitudinal edges of the clip slot (14) and the clip edge (12) are formed rounded.
